(19) United States
(12) Patent Application Publication
(10) Pub. No.: US 2025/0232899 A1
(43) Pub. Date: Jul. 17, 2025

(54) ELECTRONIC COMPONENT AND FILM FORMING METHOD

(71) Applicant: Murata Manufacturing Co., Ltd., Nagaokakyo-shi (JP)

(72) Inventors: Tomoya OOSHIMA, Nagaokakyo-shi (JP); Kojiro TOKIEDA, Nagaokakyo-shi (JP); Yuuta HOSHINO, Nagaokakyo-shi (JP); Koichi YAMADA, Nagaokakyo-shi (JP); Miki SASAKI, Nagaokakyo-shi (JP)

(73) Assignee: Murata Manufacturing Co., Ltd., Nagaokakyo-shi (JP)

(21) Appl. No.: 19/170,072

(22) Filed: Apr. 4, 2025

Related U.S. Application Data
(63) Continuation of application No. PCT/JP2023/027615, filed on Jul. 27, 2023.

(30) Foreign Application Priority Data
Oct. 12, 2022 (JP) 2022-163742

(51) Int. Cl. H01C 1/142; H01C 7/00; H01C 17/18

(52) U.S. Cl. CPC H01C 1/142; H01C 7/008; H01C 17/18

(57) ABSTRACT

An electronic component includes: a base body 20; an external electrode that covers a part of an outer surface of the base body; and an aluminum oxide protective film. The protective film is located between the base body (and the external electrode. The thickness of the protective film in a direction perpendicular to the outer surface of the base body is defined as a film thickness (TP). The protective film is, at a site covered with the external electrode, viewed in a section that is orthogonal to the outer surface of the base body. When the average value and standard deviation of the film thickness (TP) are obtained in a range of 1 μm in a direction along the outer surface of the base body, the ratio of the standard deviation to the average value is 0.4 or more.

### CROSS-REFERENCE TO RELATED APPLICATIONS

This application is a Continuation of PCT International Application No. PCT/JP2023/027615, filed on Jul. 27, 2023, which claims priority under 35 U.S.C. § 119 (a) to Patent Application No. 2022-163742, filed in Japan on Oct. 12, 2022, all of which are hereby expressly incorporated by reference into the present application.

### TECHNICAL FIELD

The present disclosure relates to an electronic component and a film forming method.

### BACKGROUND ART

The electronic component described in Patent Document 1 includes a base body and an external electrode. The base body is made of a ceramic. The external electrode covers a part of the outer surface of the base body. In addition, the external electrode is formed by applying a conductive paste containing a glass powder to the outer surface of the base body and firing the paste. The base body has a reactive layer at a site in contact with the external electrode. The reactive layer is formed by causing a reaction between a glass component contained in the conductive paste and a ceramic component of the base body. The presence of the reactive layer prevents the base body from being eroded by plating solutions and solder fluxes.

### PRIOR ART DOCUMENT

### Patent Document

Patent Document 1: Japanese Patent Application Laid-Open No. 2000-040635

### SUMMARY OF THE INVENTION

### Problem to be Solved by the Invention

In such an electronic component as described in Patent Document 1, for example, low-softening-point glass needs to be contained in the conductive paste in order to cause the base body to form a reactive layer. Then, at the time of firing the conductive paste, the glass component contained in the conductive paste is more likely to flow to the outer surface of the molten conductive paste. As a result, the glass component is more likely to be deposited on the outer surface of the external electrode after firing the conductive paste. With a large amount of glass component deposited on the outer surface of the external electrode as described above, a film formation failure is likely to occur when the outer surface of the external electrode is subjected to film formation processing such as plating processing. Accordingly, a technique for keeping the base body from being eroded by plating solutions and solder fluxes is required separately from the formation of the reactive layer at the base body.

### Means for Solving the Problem

In order to solve the problem mentioned above, an electronic component according to an aspect of the present disclosure includes: a base body; an external electrode that covers a part of the outer surface of the base body; and an aluminum oxide protective film, the protective film is located between the base body and the external electrode, the thickness of the protective film in a direction perpendicular to the outer surface of the base body is defined as a film thickness, and when the protective film is, at a site covered with the external electrode, viewed in a section that is orthogonal to the outer surface of the base body, and when the average value and standard deviation of the film thickness are determined in a range of 1 μm in a direction along the outer surface of the base body, the ratio of the standard deviation to the average value is 0.4 or more.

In addition, in order to solve the problem mentioned above, a film forming method according to an aspect of the present disclosure is a film forming method for forming a protective film that is an aluminum oxide film on an outer surface of a base body, including: a laminated body preparing step of preparing the base body; a first polishing step of polishing the base body with a first polishing powder that is an aluminum oxide powder; and a second polishing step of polishing the base body with a second polishing powder that is an aluminum oxide powder after the first polishing step, when a central particle diameter that is the mode of particle diameters in a particle size distribution is compared between the first polishing powder and the second polishing powder, the central particle diameter of the second polishing powder is 1/10 or less of the central particle diameter of the first polishing powder.

In accordance with the configuration mentioned above, the coefficient of variation of the film thickness of the protective film is 0.4 or more, and thus, the film thickness varies in a relatively wide manner. More specifically, the protective film has an infinite number of irregularities at the outer surface. Thus, an anchor effect is produced, thereby causing the protective film to increase the adhesion of a glass film to the protective film and the adhesion of the external electrode to the glass film. As described above, the high adhesion of the respective layers laminated on the outer surface of the protective film allows plating solutions, solder fluxes, and the like to be prevented from entering from the boundary surfaces between the respective layers. Accordingly, the base body can be kept from being eroded due to the plating solutions, the solder fluxes, and the like.

In addition, the outer surface of the protective film has an infinite number of irregularities, and thus, the metal particles in the protective film are kept from flowing in the curing step. In this case, the metal particles of the conductive paste are also constrained by the metal particles in the protective film, and thus, the metal particles of the conductive paste have flowability reduced. Further, when the metal particles of the conductive paste have low flowability, the glass component is constrained in the gaps between the metal particles, and thus, the glass component is less likely to flow to the outer surface of the molten conductive paste. Accordingly, the glass is less likely to be deposited on the surface of the external electrode after firing the conductive paste.

### Advantageous Effect of the Invention

The base body can be prevented from being eroded by plating solutions and solder fluxes.

### BRIEF EXPLANATION OF DRAWINGS

FIG. 1 is a perspective view of an electronic component.

FIG. 2 is a side view of the electronic component.

FIG. 3 is a sectional view along the line 3-3 in FIG. 2.

FIG. 4 is an enlarged sectional view of a protective film and the vicinity thereof.

FIG. 5 is an enlarged sectional view of the protective film and vicinity thereof.

FIG. 6 is a flowchart illustrating a method for manufacturing an electronic component.

FIG. 7 is an explanatory diagram illustrating the method for manufacturing an electronic component.

FIG. 8 is an explanatory diagram illustrating the method for manufacturing an electronic component.

FIG. 9 is an explanatory diagram illustrating the method for manufacturing an electronic component.

FIG. 10 is an explanatory diagram illustrating the method for manufacturing an electronic component.

FIG. 11 is an explanatory diagram illustrating the method for manufacturing an electronic component.

### MODE FOR CARRYING OUT THE INVENTION

### <Embodiment of Electronic Component>

Hereinafter, an embodiment of the electronic component will be described with reference to the drawings. It is to be noted that components may be shown in an enlarged manner for easy understanding in the drawings. The dimensional ratios of the components may be different from the actual ones or those in another drawing.

### (As for Overall Configuration)

As shown in FIG. 1, an electronic component 10 is, for example, a surface-mount negative-characteristic thermistor component to be mounted on a circuit board or the like. It is to be noted that the negative-characteristic thermistor component has a characteristic that the resistance value is decreased as the temperature is increased.

The electronic component 10 includes a base body 20. The base body 20 has a substantially quadrangular prism shape and has a central axis CA. Hereinafter, an axis extending along the central axis CA is defined as a first axis X. In addition, one of axes that are orthogonal to the first axis X is defined as a second axis Y. Further, an axis that is orthogonal to the first axis X and the second axis Y is defined as a third axis Z. Furthermore, one of the directions along the first axis X is defined as a first positive direction X1, and the direction opposite to the first positive direction X1, of the directions along the first axis X, is defined as a first negative direction X2. In addition, one of the directions along the second axis Y is defined as a second positive direction Y1, and the direction opposite to the second positive direction Y1, of the directions along the second axis Y, is defined as a second negative direction Y2. Furthermore, one of the directions along the third axis Z is defined as a third positive direction Z1, and the direction opposite to the third positive direction Z1, of the directions along the third axis Z, is defined as a third negative direction Z2.

An outer surface 21 of the base body 20 has six flat faces 22. It is to be noted that the term “face” of the base body 20 as used herein refers to a part that can be observed as a face when the whole base body 20 is observed. More specifically, for example, if there are such minute irregularities or steps that fail to be found unless a part of the base body 20 is enlarged and observed with a microscope or the like, the face is expressed as a flat face or a curved face. The six flat faces 22 extend in directions that are different from each other. The six flat faces 22 are roughly divided into a first end surface 22A that faces in the first positive direction X1, a second end surface 22B that faces in the first negative direction X2, and four side surfaces 22C. The four side surfaces 22C are a surface that faces in the third positive direction Z1, a surface that faces in the third negative direction 22, a surface that faces in the second positive direction Y1, and a surface that faces in the second negative direction Y2.

The outer surface 21 of the base body 20 has twelve boundary surfaces 23. The boundary surface 23 includes a curved surface at the boundary between the adjacent flat faces 22. More specifically, the boundary surface 23 includes, for example, a curved surface formed by round chamfering of a corner formed by the adjacent flat faces 22.

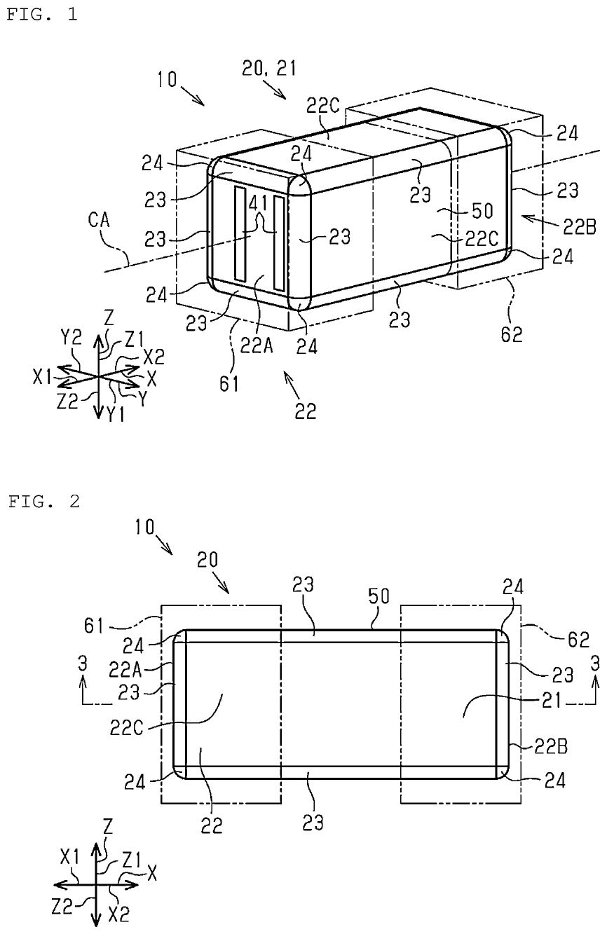

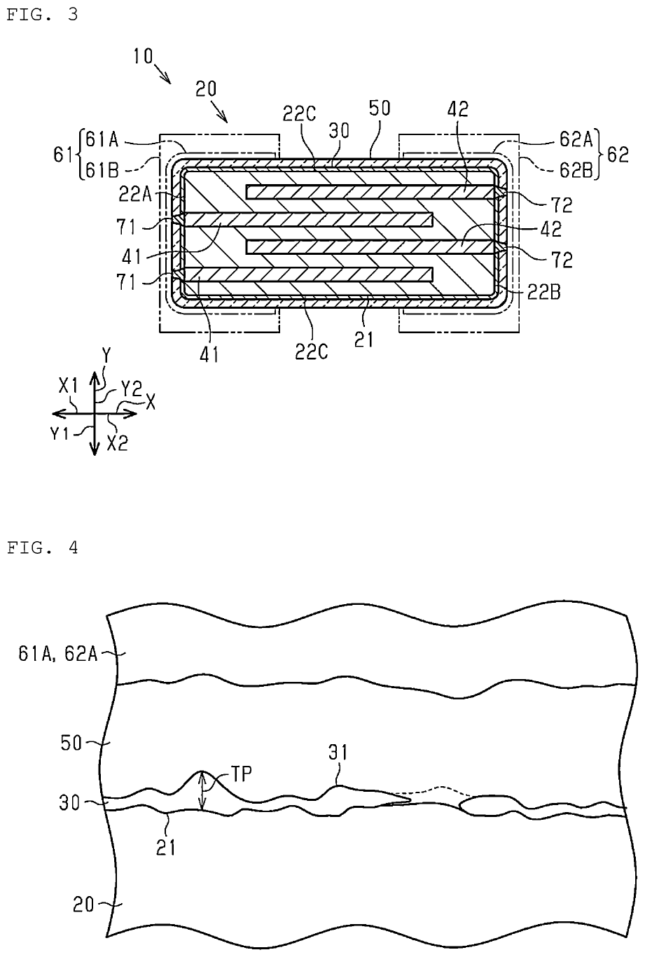

In addition, the outer surface 21 of the base body 20 has eight spherical corner surfaces 24. The corner surface 24 is a boundary part among three adjacent flat faces 22. In other words, the corner surface 24 includes a curved surface at a site where three boundary surfaces 23 intersect with each other. More specifically, the corner surface 24 includes, for example, a curved surface formed by round chamfering of a corner formed by the three adjacent flat faces 22. It is to be noted that a surface of a glass film 50 to be described later is designated by the same reference numerals as with the outer surface 21 of the base body 20 in FIGS. 1 and 2.

As shown in FIG. 2, the base body 20 is larger in dimension in the direction along the first axis X than in dimension in the direction along the third axis Z. In addition, as shown in FIG. 1, the base body 20 has a dimension in the direction along the first axis X larger than a dimension in the direction along the second axis Y. In addition, the material of the base body 20 is a ceramic obtained by firing a metal oxide containing at least one of Mn, Fe, Ni, Co, Ti, Ba, Al, and Zn as a component.

As shown in FIG. 3, the electronic component 10 includes two first internal electrodes 41 and two second internal electrodes 42. The first internal electrodes 41 and the second internal electrodes 42 are embedded in the base body 20.

The material of the first internal electrodes 41 is a conductive material. For example, the material of the first internal electrode 41 is palladium. In addition, the material of the second internal electrodes 42 is the same as the material of the first internal electrodes 41.

The first internal electrode 41 has a rectangular plate shape. The first internal electrode 41 has a main surface that is orthogonal to the second axis Y. The second internal electrode 42 has the same rectangular plate shape as the first internal electrode 41. The second internal electrode 42 has a main surface that is orthogonal to the second axis Y, as with the first internal electrode 41.

The dimension of the first internal electrode 41 in the direction along the first axis X is smaller than the dimension of the base body 20 in the direction along the first axis X. In addition, as shown in FIG. 1, the dimension of the first internal electrode 41 in the direction along the third axis Z is approximately ⅔ of the dimension of the base body 20 in the direction along the third axis Z. The dimensions of the second internal electrode 42 in each of the directions are the same as those of the first internal electrode 41.

As shown in FIG. 3, the first internal electrodes 41 and the second internal electrodes 42 are located in a staggered manner in the direction along the second axis Y. More specifically, the first internal electrode 41, the second internal electrode 42, the first internal electrode 41, and the second internal electrode 42 are arranged in this order in the second negative direction Y2 from the side surface 22C facing in the second positive direction Y1. According to this embodiment, the distances between the respective internal electrodes in the direction along the second axis Y are equal to each other.

As shown in FIG. 1, the two first internal electrodes 41 and the two second internal electrodes 42 are both located at the center of the base body 20 in the direction along the third axis Z. On the other hand, as shown in FIG. 3, the first internal electrodes 41 are located to be shifted in the first positive direction X1. The second internal electrodes 42 are located to be shifted in the first negative direction X2.

Specifically, an end of the first internal electrode 41 in the first positive direction X1 coincides with an end of the base body 20 in the first positive direction X1. The end of the first internal electrode 41 in the first negative direction X2 is located inside the base body 20, without reaching the end of the base body 20 on the first negative direction X2. On the other hand, an end of the second internal electrode 42 in the first negative direction X2 coincides with an end of the base body 20 in the first negative direction X2. The end of the second internal electrode 42 in the first positive direction X1 is located inside the base body 20, without reaching the end of the base body 20 in the first positive direction X1.

As shown in FIG. 3, the electronic component 10 includes a protective film 30. The protective film 30 covers the outer surface 21 of the base body 20. According to the present embodiment, the protective film 30 covers substantially the whole region of the outer surface 21 of the base body 20. As shown in FIG. 4, however, when an outer surface 31 of the protective film 30 is enlarged and observed with a microscope or the like, the protective film 30 is dotted with holes. More specifically, the outer surface 21 of the base body 20 is exposed from the protective film 30 at the holes. It is to be noted that the protective film 30 is illustrated as if the uniform thickness thereof covers the outer surface 21 of the base body 20 in FIG. 3, for conceptually illustrating that the protective film 30 is located between the base body 20 and the glass film 50. The material of the protective film 30 is an aluminum oxide, specifically, alumina.

The electronic component 10 includes a glass film 50. The glass film 50 covers the outer surface 31 of the protective film 30 and the outer surface 21 of the base body 20. Specifically, the glass film 50 covers the whole region of the outer surface 31 of the protective film 30. Further, the glass film 50 also covers the outer surface 21 of the base body 20 exposed from the protective film 30 at the holes. The material of the glass film 50 is insulating glass containing silicon dioxide as a main component.

As shown in FIG. 3, the electronic component 10 includes a first external electrode 61 and a second external electrode 62. The first external electrode 61 includes a first underlying electrode 61A and a first metal layer 61B. The first underlying electrode 61A is laminated on the glass film 50 at a part of the outer surface 21 of the base body 20, including the first end surface 22A. Specifically, the first underlying electrode 61A is a five-face electrode that covers the first end surface 22A of the base body 20 and parts of the four side surfaces 22C thereof in the first positive direction X1. According to this embodiment, the material of the first underlying electrode 61A is a mixture of silver and glass.

The first metal layer 61B covers the first underlying electrode 61A from the outside. More specifically, the first metal layer 61B is laminated on the first underlying electrode 61A. The first metal layer 61B has a two-layer structure of nickel plating and tin plating in this order from the side of the base body 20.

The second external electrode 62 includes a second underlying electrode 62A and a second metal layer 62B. The second underlying electrode 62A is laminated on the glass film 50 at a part of the outer surface 21 of the base body 20, including the second end surface 22B. Specifically, the second underlying electrode 62A is a five-face electrode that covers the second end surface 22B of the base body 20 and parts of the four side surfaces 22C thereof in the first negative direction X2. According to this embodiment, the material of the second underlying electrode 62A is the same as the material of the first external electrode 61, which is a mixture of silver and glass.

The second metal layer 62B covers the second underlying electrode 62A from the outside. More specifically, the second metal layer 62B is laminated on the second underlying electrode 62A. The second metal layer 62B has, as with the first metal layer 61B, a two-layer structure of nickel plating and tin plating in this order from the side of the base body 20.

The second external electrode 62 is, without reaching the first external electrode 61 on the side surface 22C, disposed away from the first external electrode 61 in the direction along the first axis X. Further, on the side surface 22C of the base body 20, the first external electrode 61 and the second external electrode 62 are not laminated with the glass film 50 exposed at the central part in the direction along the first axis X. It is to be noted that the first external electrode 61 and the second external electrode 62 are indicated by two-dot chain lines in FIGS. 1 to 3.

As shown in FIG. 3, the first external electrode 61 and the end of the first internal electrode 41 in the first positive direction X1 are connected via a first penetrating part 71 penetrating the protective film 30 and the glass film 50. More specifically, the first penetrating part 71 is a connection part that connects the first external electrode 61 and the first internal electrode 41. Although details will be described later, the first penetrating part 71 is formed by extension of palladium constituting the first internal electrode 41 toward the first external electrode 61 in the process of manufacturing the electronic component 10.

In addition, the second external electrode 62 and the end of the second internal electrode 42 in the first negative direction X2 are connected via a second penetrating part 72 penetrating the protective film 30 and the glass film 50. More specifically, the second penetrating part 72 is a connection part that connects the second external electrode 62 and the second internal electrode 42. The second penetrating part 72 is also, as with the first penetrating part 71, formed by extension of palladium constituting the second internal electrode 42 toward the second external electrode 62 in the process of manufacturing the electronic component 10. While the first internal electrode 41 and the first penetrating part 71 are illustrated as separate members with a boundary in FIG. 3, there is actually no clear boundary therebetween. In this respect, the same applies to the second penetrating part 72. In addition, the illustration of the first penetrating part 71 and second penetrating part 72 is omitted in FIGS. 1 and 2.

### (As for Protective Film)

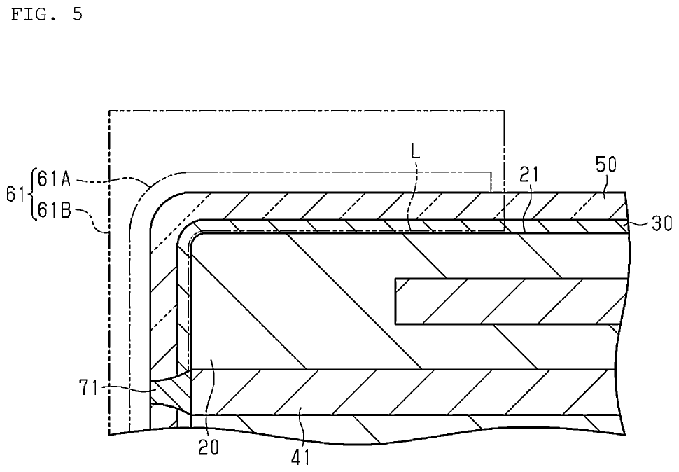

The protective film 30 is always present between the end edge of the first external electrode 61 and the first penetrating part 71 that is a connection part between the first internal electrode 41 and the first external electrode 61. Specifically, as shown in FIG. 5, a perpendicular line is drawn from an arbitrary point on the end edge of the first external electrode 61 to the outer surface 21 of the base body 20. Then, an imaginary line L connecting the foot of the perpendicular line to an arbitrary point of the first penetrating part 71 is drawn along the outer surface 21 of the base body 20 from the foot. In this regard, as described above, the protective film 30 covers substantially the whole region of the outer surface 21 of the base body 20. Accordingly, the imaginary lines L all overlap with the region where the protective film 30 is present, regardless of where on the end edge of the first external electrode 61 the arbitrary point is defined or where of the first penetrating part 71 the arbitrary point is defined. In this respect, the same applies to the second external electrode 62 and the second penetrating part 72.

In this regard, the film thickness TP of the protective film 30 is defined as a thickness in a direction perpendicular to the outer surface 21 of the base body 20. Furthermore, as shown in FIG. 4, the site where the base body 20 is covered with the first external electrode 61 or the second external electrode 62 is viewed in a section that is orthogonal to the outer surface 21 of the base body 20. Then, the average value and the standard deviation of the film thickness TP of the protective film 30 are obtained in a range of 1 μm along the outer surface 21 of the base body 20. The thus obtained ratio of the standard deviation to the average value is defined as a coefficient of variation. In this case, the coefficient of variation of the film thickness TP of the protective film 30 is 0.4 or more at the site covered with the first external electrode 61 or the second external electrode 62. It is to be noted that the average value of the film thickness TP of the protective film 30 is 100 nm or less in the present embodiment. In addition, the standard deviation of the film thickness TP of the protective film 30 is 10 nm or more. According to this embodiment, the average value of the film thickness TP of the protective film 30 is 27 nm, and the standard deviation thereof is 13 nm. Accordingly, the coefficient of variation in this embodiment is about 0.48.

### <Method for Manufacturing Electronic Component>

Next, a method for manufacturing the electronic component 10 and a method for forming the protective film 30 will be described.

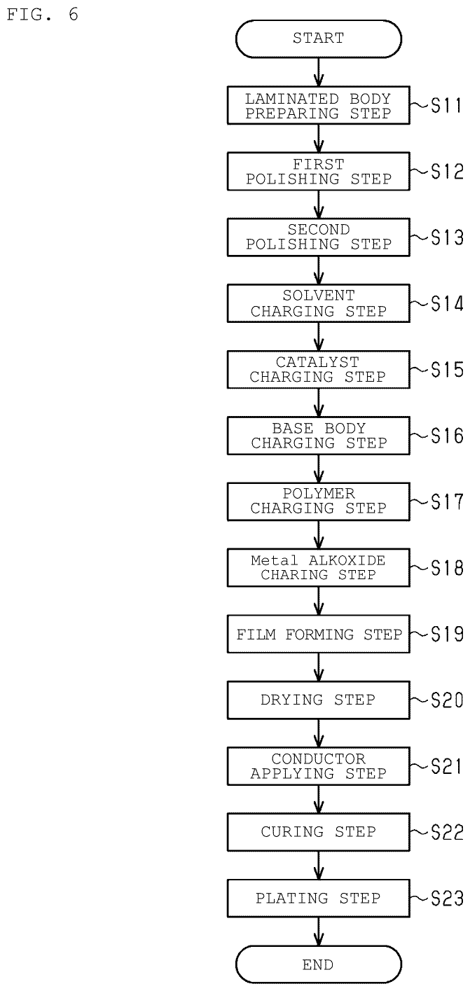

As shown in FIG. 6, the method for manufacturing the electronic component 10 includes a laminated body preparing step S11, a first polishing step S12, a second polishing step S13, a solvent charging step S14, a catalyst charging step S15, a base body charging step S16, a polymer charging step S17, and a metal alkoxide charging step S18. In addition, the method for manufacturing the electronic component 10 further includes a film forming step S19, a drying step S20, a conductor applying step S21, a curing step S22, and a plating step S23.

First, for forming the base body 20, a laminated body, which is the base body 20 without the boundary surfaces 23 or the corner surfaces 24, is prepared in the laminated body preparing step S11. More specifically, the stacked body, which is a state before round chamfering, has a rectangular parallelepiped shape with the six flat faces 22. For example, first, a plurality of ceramic sheets to serve as the base body 20 is prepared. The sheet has a thin plate shape. On the sheet, a conductive paste to serve as the first internal electrode 41 is stacked. On the stacked paste, the ceramic sheet to serve as the base body 20 is stacked. On the sheet, a conductive paste to serve as the second internal electrode 42 is stacked. In this manner, the ceramic sheet and the conductive paste are stacked. Then, an unfired stacked body is formed by cutting into a predetermined size. Thereafter, the unfired stacked body is subjected to firing at a high temperature to provide a laminated body.

Next, the first polishing step S12 is performed. In the first polishing step S12, the boundary surfaces 23 and the corner surfaces 24 are formed for the laminated body prepared in the laminated body preparing step S11. Specifically, the corners of the laminated body are subjected to round chamfering by barrel polishing to form the boundary surfaces 23 with curved surfaces and the corner surfaces 24 with curved surfaces. In addition, in the first polishing step S12, the barrel polishing is performed with the use of a first polishing powder, which is an aluminum oxide powder. A part of the first polishing powder used in the first polishing step S12 adheres to the outer surface of the laminated body.

Next, the second polishing step S13 is performed. In the second polishing step S13, the laminated body polished in the first polishing step S12 is further polished. In the second polishing step S13, barrel polishing is performed with the use of a second polishing powder, which is an aluminum oxide powder. In this regard, when the central particle diameter that is the mode of particle diameters in a particle size distribution is compared between the first polishing powder and the second polishing powder, the central particle diameter of the second polishing powder is 1/10 or less of the central particle diameter of the first polishing powder. The first polishing powder adhering to the laminated body in the first polishing step S12 is subjected to pulverization in the second polishing step S13. In addition, a part of the second polishing powder used in the second polishing step S13 adheres to the outer surface of the laminated body. As a result, the aluminum oxide powder with various particle sizes adheres to the outer surface 21 of the base body 20. It is to be noted that the aluminum oxide powder adhering to the outer surface 21 of the base body 20 is stuck or buried in the outer surface 21 of the base body 20. In addition, a part of the aluminum oxide powder is surface-fused to the outer surface 21 of the base body 20. Thus, the aluminum oxide powder does not easily fall from the outer surface 21 of the base body 20. Accordingly, the protective film 30 is formed on the outer surface 21 of the base body 20.

Next, the solvent charging step S14 is performed. As shown in FIG. 7, 2-propanol is put as a solvent 82 into a reaction vessel 81 in the solvent charging step S14.

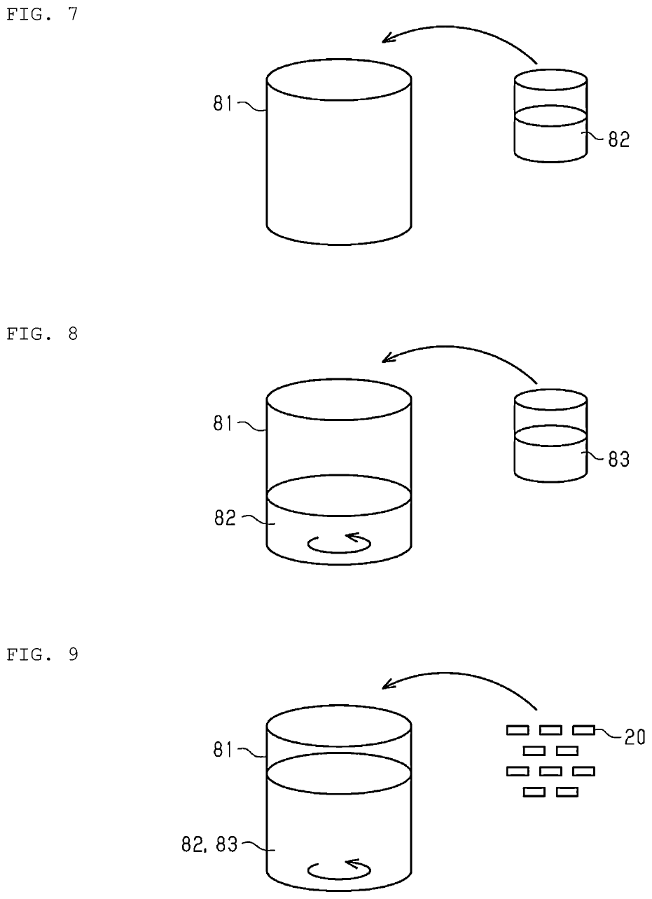

Next, as shown in FIG. 6, the catalyst charging step S15 is performed. As shown in FIG. 8, first, the solvent 82 in the reaction vessel 81 is started to be stirred in the catalyst charging step S15. Then, as an aqueous solution 83 containing a catalyst, ammonia water is put into the reaction vessel 81. The catalyst in this embodiment, which is a hydroxide ion, functions as a catalyst that promotes hydrolysis of a metal alkoxide 85 described later.

Next, as shown in FIG. 6, the base body charging step S16 is performed. As shown in FIG. 9, a plurality of base bodies 20 formed in advance in the second polishing step S13 as described above is put into the reaction vessel 81 in the base body charging step S16.

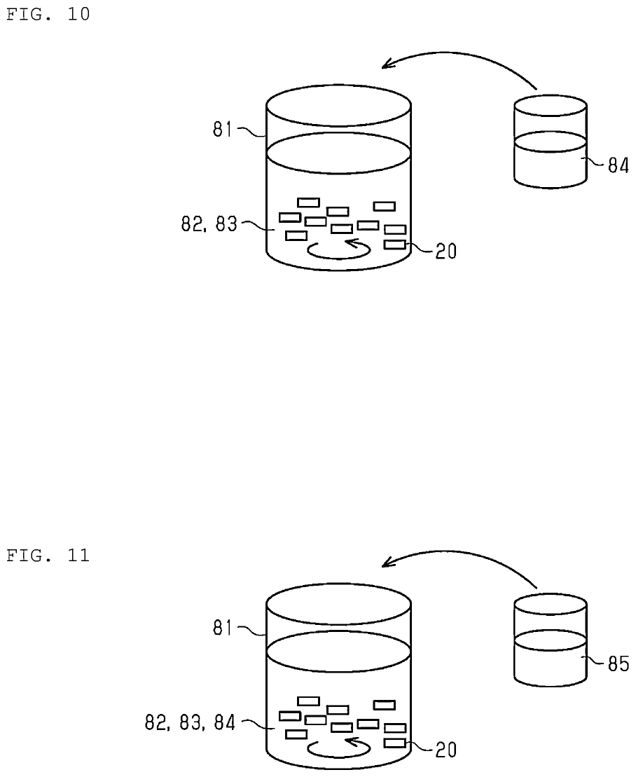

Next, as shown in FIG. 6, the polymer charging step S17 is performed. As shown in FIG. 10, a polyvinylpyrrolidone is put as a polymer 84 into the reaction vessel 81 in the polymer charging step S17. Thus, the polymer 84 put into the reaction vessel 81 adsorbs to the outer surfaces 21 of the base bodies 20.

Next, as shown in FIG. 6, the metal alkoxide charging step S18 is performed. As shown in FIG. 11, a liquid tetraethyl orthosilicate is put as the metal alkoxide 85 into the reaction vessel 81 in the metal alkoxide charging step S18. It is to be noted that the tetraethyl orthosilicate may be referred to as a tetraethoxysilane. In the present embodiment, the amount of the metal alkoxide 85 put in the metal alkoxide charging step S18 is calculated based on the area of the outer surfaces 21 of the base bodies 20 put in the base body charging step S16. Specifically, the amount is calculated by multiplying the amount of the metal alkoxide 85 per base body 20, required for forming the glass film 50 covering the outer surface 21 of the base body 20, by the number of base bodies 20.

Next, as shown in FIG. 6, the film forming step S19 is performed. In the film forming step S19, the stirring of the solvent 82, started in the solvent charging step S14 described above, is continued for a predetermined period of time, after the metal alkoxide 85 is put into the reaction vessel 81 in the metal alkoxide charging step S18.

In the film forming step S19, the glass film 50 is formed by a liquid phase reaction in the reaction vessel 81.

Next, the drying step S20 is performed. In the drying step S20, after the stirring is continued for the predetermined period of time in the film forming step S19, the base bodies 20 are taken out from the reaction vessel 81, and then dried. Thus, the glass film 50 in the sol form is dried to become the glass film 50 in a gel form.

Next, the conductor applying step S21 is performed. In the conductor applying step S21, a conductor paste is applied to two parts of the surface of the glass film 50: a part including a part that covers the first end surface 22A of the base body 20; and a part including a part that covers the second end surface 22B of the base body 20. Specifically, the conductor paste is applied so as to cover the glass film 50 on the whole region of the first end surface 22A and parts of the four side surfaces 22C. In addition, the conductor paste is applied so as to cover the glass film 50 on the whole region of the second end surface 22B and parts of the four side surfaces 22C.

Next, the curing step S22 is performed. Specifically, the base bodies 20 with the glass film 50 and conductor paste applied thereto are heated in the curing step S22. Thus, firing proceeds for the protective film 30 formed on the outer surface 21 of the base body 20. In addition, the vaporization of water and the polymer 84 from the glass film 50 in the gel form causes the glass film 50 covering the protective film 30 to be fired and cured as shown in FIG. 3. Furthermore, in the curing step S22, the conductor paste applied in the conductor applying step S21 is fired to form the first underlying electrode 61A and the second underlying electrode 62A.

In the present embodiment, at the time of heating in the curing step S22, the palladium contained on the side with the first internal electrodes 41 is attracted toward the side with first underlying electrode 61A containing silver by the Kirkendall effect caused from the difference in diffusion rate between the first internal electrodes 41 and the first underlying electrode 61A. Thus, the first penetrating parts 71 penetrate and then extend through the protective film 30 and the glass film 50 from the first internal electrodes 41 toward the first underlying electrode 61A, thereby connecting the first internal electrodes 41 and the first underlying electrode 61A to each other. In this respect, the same applies to the second penetrating parts 72 that connect the second internal electrodes 42 and the second underlying electrode 62A.

Next, the plating step S23 is performed. Parts of the first underlying electrode 61A and second underlying electrode 62A are subjected to electroplating. Thus, the first metal layer 61B is formed on the surface of the first underlying electrode 61A. In addition, the second metal layer 62B is formed on the surface of the second underlying electrode 62A. Although not illustrated, the first metal layer 61B and the second metal layer 62B each have a two-payer structure electroplated with two types: nickel and tin. In this manner, the electronic component 10 is formed.

### (As for Effects of Present Embodiment)

(1) According to the embodiment mentioned above, the coefficient of variation of the film thickness TP of the protective film 30 is 0.4 or more, and thus, the film thickness TP varies in a relatively wide manner. More specifically, the protective film 30 has an infinite number of irregularities at the outer surface 31. Thus, an anchor effect is produced, thereby increasing the adhesion of the glass film 50 to the protective film 30 and the adhesion of the first external electrode 61 and the second external electrode 62 to the glass film 50. As described above, the high adhesion of the respective layers laminated on the outer surface 31 of the protective film 30 allows plating solutions, solder fluxes, and the like to be prevented from entering from the boundary surfaces between the respective layers. Accordingly, the base body 20 can be kept from being eroded due to the plating solutions, the solder fluxes, and the like.

In addition, the outer surface 31 of the protective film 30 has an infinite number of irregularities, and thus, the metal particles in the protective film 30 is kept from flowing in the curing step S22. In this case, the metal particles of the conductive paste are also constrained by the metal particles in the protective film 30, and thus, the metal particles of the conductive paste have flowability reduced. Further, when the metal particles of the conductive paste have low flowability, the glass component is constrained in the gaps between the metal particles, and thus, the glass component is less likely to flow to the outer surface of the molten conductive paste. Accordingly, the glass is less likely to be deposited on the surface of the external electrode after firing the conductive paste.

(2) According to the embodiment mentioned above, the average value of the film thickness TP of the protective film 30 is 100 nm or less. The protective film 30 is formed to be thin as described above, and thus, the formation of the first penetrating part 71 and the second penetrating part 72 by the Kirkendall effect is less likely to be hindered. More specifically, the connectivity between the first internal electrode 41 and the first external electrode 61 and the connectivity between the second internal electrode 42 and the second external electrode 62 can be secured.

(3) In the embodiment mentioned above, the standard deviation of the film thickness TP of the protective film 30 is 10 nm or more. When the film thickness TP of the protective film 30 varies considerably as described above, the outer surface of the glass film 50 laminated on the outer surface 31 of the protective film 30 also varies considerably in a manner that follows the shape of the protective film 30. Thus, the anchor effect of the first external electrode 61 and the second external electrode 62 on the glass film 50 is more likely to be achieved.

(4) According to the embodiment mentioned above, the protective film 30 is always present between the end edge of the first external electrode 61 and the first penetrating part 71 that is a connection part between the first internal electrode 41 and the first external electrode 61. The presence blocks the entering path of plating solutions, fluxes, and the like entering from the end edge of the first external electrode 61 to the connection part. Thus, a connection failure or the like between the first external electrode 61 and the first internal electrode 41 can be prevented. In this respect, the same applies to the second external electrode 62, the second internal electrode 42, and the second penetrating part 72.

(5) According to the embodiment mentioned above, the glass film 50 is interposed between the protective film 30 and the first external electrode 61 and second external electrode 62. Thus, the effect of protecting the base body 20 can be achieved by not only the protective film 30 but also the glass film 50. Furthermore, the glass component contained in the conductive paste is diffused into and then integrated with the glass film 50, thereby improving the joint strength between the glass film 50 and the first external electrode 61 and second external electrode 62. Accordingly, each of the external electrode is less likely to be peeled from the base body 20.

(6) According to the embodiment mentioned above, the central particle diameter of the second polishing powder is significantly smaller than that of the first polishing powder. The use of two types of polishing powders that differ in central particle diameter allows the protective film 30 that varies widely in film thickness TP to be formed on the outer surface 21 of the base body 20 without adding any special process for surface roughening.

### Modification Examples

The above-mentioned embodiment and the following modification examples can be implemented in combination within a range that is not technically contradictory.

In the embodiment, the electronic component 10 is not limited to any negative-characteristic thermistor component. For example, the electronic component 10 may be a thermistor component other than those that have negative characteristics, or may be a multilayer capacitor component or an inductor component, as long as the electronic component 10 includes some wiring inside the base body 20.

The outer surface 21 of the base body 20 has only to have the protective film 30 formed, and may have no boundary surface 23 or corner surface 24. For example, when the boundary between the adjacent flat faces 22, of the outer surface 21 of the base body 20, has no chamfered shape, the boundary has no curved surface. Thus, in such a case, there may be no boundary surface 23 or corner surface 24.

The shapes of the first internal electrodes 41 and second internal electrodes 42 are not limited as long as the shapes can ensure electrical conduction with the corresponding first external electrode 61 and second external electrode 62. In addition, the numbers of the first internal electrodes 41 and second internal electrodes 42 are not limited, and the numbers of the internal electrodes may be one or may be three or more.

The configuration of the first external electrode 61 is not limited to the example of the embodiment mentioned above. For example, the first external electrode 61 may include only the first underlying electrode 61A, or the first metal layer 61B may have no two-layer structure. In this respect, the same applies to the second external electrode 62.

The combination of the materials of the first internal electrode 41 and first underlying electrode 61A is not limited to the combination of palladium and silver. The combination may be, for example, a combination of copper and nickel, copper and silver, silver and gold, nickel and cobalt, or nickel and gold. For example, the combination may have: silver as one of the materials; and a combination of silver and palladium as the other. For example, the combination may have: palladium as one of the materials; and a combination of silver and palladium as the other, or may have: copper as one of the materials; and a combination of silver and palladium as the other. For example, the combination may have: gold as one of the materials; and a combination of silver and palladium as the other.

Depending on the combination of the first internal electrode 41 and the first underlying electrode 61A, no Kirkendall effect may be achieved. In this case, before the external electrode forming step, the first internal electrode 41 may be processed to be exposed. For example, the base body 20 may be polished on the side with the first end surface 22A to physically remove parts of the protective film 30 and glass film 50. Thereafter, performing the underlying electrode forming step can connect the first internal electrode 41 and the first underlying electrode 61A. In this case, a face of the first internal electrode 41, exposed from the outer surface 21 of the base body 20, is a connection part. In this respect, the same applies to the combination of the materials of the second internal electrodes 42 and second underlying electrode 62A.

The site where the first external electrode 61 is disposed is not limited to the example of the embodiment mentioned above. For example, the first external electrode 61 may be disposed only on the first end surface 22A and one of the side surfaces 22C. In this respect, the same applies to the second external electrode 62.

The conductive metals included in the first underlying electrode 61A and the second underlying electrode 62A do not have to be the same as each other. For example, the first underlying electrode 61A may contain Ag, whereas the second underlying electrode 62A may contain Cu.

The protective film 30 does not have to cover the whole outer surface 21 of the base body 20. For example, the protective film 30 may cover only sites of the outer surface 21 of the base body 20, covered with the first external electrode 61 and the second external electrode 62, without covering the other outer surface 21 of the base body 20. In addition, for example, only the periphery of the connection parts between the first internal electrodes 41 and the first external electrode 61 or the connection parts between the second internal electrodes 42 and the second external electrode 62 may be covered with the protective film 30 at the outer surface 21 of the base body 20.

The average value of the film thickness TP of the protective film 30 may be larger than 100 nm. For example, as long as the first internal electrodes 41 and the first external electrode 61 are not connected by the first penetrating parts 71 formed by the Kirkendall effect, there are few adverse effects if the average value of the film thickness TP is larger than 100 nm.

The standard deviation of the film thickness TP of the protective film 30 may be less than 10 nm. If the standard deviation of the film thickness TP is 10 nm or more, the adhesion of the glass film 50 and the respective external electrodes to the protective film 30 can be ensured as long as the coefficient of variation is 0.4 or more.

The protective film 30 does not have to be always present between the end edge of the first external electrode 61 and the first penetrating part 71 that is a connection part between the first internal electrode 41 and the first external electrode 61. More specifically, in the case of drawing imaginary lines L along the outer surface 21 of the base body 20, for connecting: the foots of perpendicular lines drawn from arbitrary points on the end edge of the first external electrode 61 to the outer surface 21 of the base body 20; and arbitrary points of the first penetrating part 71, some of the imaginary lines L do not have to overlap with the region where the protective film 30 is present. In this respect, the same applies to the relationship between the second external electrode 62 and the second penetrating part 72.

The glass film 50 does not have to cover the whole region of the outer surface 31 of the protective film 30. The range covered by the glass film 50 may be changed appropriately in accordance with the shape of the base body 20, the positions of the first external electrode 61 and second external electrode 62, and the like.

As for the part of the glass film 50 covered with the first underlying electrode 61A, the glass in the glass film 50 may be diffused into and thus integrated with the glass in the first underlying electrode 61A.

The glass film 50 may be omitted. Furthermore, another film, which is formed in a manner that follows the shape of the outer surface 31 of the protective film 30, may be formed instead of the glass film 50. More specifically, having irregularities at the outer surface of the film has only to allow high adhesion to be achieved by the anchor effect and allows glass deposition to be prevented. It is to be noted that the first underlying electrode 61A and the second underlying electrode 62A may be laminated on the outer surface 31 of the protective film 30.

In the first polishing step S12 and the second polishing step S13, the first polishing powder and the second polishing powder are preferably alumina, but the respective compositions of the powders are not restricted as long as the powders are aluminum oxide powders that differ in central particle diameter. In addition, the first polishing powder and the second polishing powder may be aluminum oxides that differ in composition.

### SUPPLEMENTARY NOTE

The technical idea that can be grasped from the embodiment modification examples mentioned above will be added below.

[1]

An electronic component including: a base body; an external electrode that covers a part of the outer surface of the base body; and an aluminum oxide protective film, in which
the protective film is located between the base body and the external electrode,
the thickness of the protective film in a direction perpendicular to the outer surface of the base body is defined as a film thickness, and
when the protective film is, at a site covered with the external electrode, viewed in a section that is orthogonal to the outer surface of the base body, and when the average value and standard deviation of the film thickness are determined in a range of 1 μm in a direction along the outer surface of the base body,
the ratio of the standard deviation to the average value is 0.4 or more.

[2]

The electronic component according to [1], in which the average value of the film thicknesses is 100 nm or less.

[3]

The electronic component according to [1] or [2], in which the standard deviation of the film thickness is 10 nm or more.

[4]

The electronic component according to any one of [1] to [3], further including: an internal electrode located inside the base body; and a connection part that connects the external electrode and the internal electrode, in which
when a perpendicular line is drawn from an arbitrary point on an end edge of the external electrode to the outer surface of the base body, and when an imaginary line connecting the foot of the perpendicular line and an arbitrary point of the connection part is drawn along the outer surface of the base body,
the imaginary lines all overlap with the region where the protective film is present.

[5]

The electronic component according to any one of [1] to [4], further including a glass film between the protective film and the external electrode.

[6]

A film forming method for forming a protective film that is an aluminum oxide film on an outer surface of a base body, including:
a laminated body preparing step of preparing the base body;
a first polishing step of polishing the base body with a first polishing powder that is an aluminum oxide powder; and
a second polishing step of polishing the base body with a second polishing powder that is an aluminum oxide powder after the first polishing step, in which
when a central particle diameter that is the mode of particle diameters in a particle size distribution is compared between the first polishing powder and the second polishing powder,
the central particle diameter of the second polishing powder is 1/10 or less of the central particle diameter of the first polishing powder.

### DESCRIPTION OF REFERENCE SYMBOLS

10: Electronic component
20: Base body
30: Protective film
31: Outer surface
50: Glass film
61: First external electrode
62: Second external electrode
71: First penetrating part
72: Second penetrating part
S12: First polishing step
S13: Second polishing step
TP: Film thickness

1. An electronic component comprising:
a base body;
an external electrode that covers a part of an outer surface of the base body;
a protective film comprised of aluminum oxide;
a glass film located between the protective film and the external electrode, wherein:
the protective film is located between the base body and the external electrode,
a thickness of the protective film in a direction perpendicular to the outer surface of the base body is defined as a film thickness,
the protective film is at a site covered with the external electrode when viewed in a section that is orthogonal to the outer surface of the base body, and
when an average value and a standard deviation of the film thickness are determined in a range of 1 μm in a direction along the outer surface of the base body, a ratio of the standard deviation to the average value is 0.4 or more.

2. The electronic component according to claim 1, wherein the average value of the film thickness is 100 nm or less.

3. The electronic component according to claim 1, wherein the standard deviation of the film thickness is 10 nm or more.

4. The electronic component according to claim 1, further comprising:
an internal electrode located inside the base body; and
a connection part that connects the external electrode and the internal electrode,
wherein when a perpendicular line is drawn from an arbitrary point on an end edge of the external electrode to the outer surface of the base body, and when an imaginary line connecting a foot of the perpendicular line and an arbitrary point of the connection part is drawn along the outer surface of the base body, the imaginary lines all overlap with a region where the protective film is present.

5. The electronic component according to claim 1, further comprising:
an internal electrode connected to the external electrode by a first penetrating part, the first penetrating part penetrates the protective film and the glass film.

6. The electronic component according to claim 1, wherein
the external electrode is a first external electrode, and
the electronic component further includes:
a second external electrode that covers another part of the outer surface of the base body.

7. The electronic component according to claim 6, wherein the electronic component further includes:
a first internal electrode connected to the first external electrode by a first penetrating part; and
a second internal electrode connected to the second external electrode by a second penetrating part.

8. The electronic component according to claim 7,
wherein:
the first penetrating part penetrates the protective film and the glass film, and
the second penetrating part penetrates the protective film and the glass film.

9. A film forming method comprising:
a laminated body preparing step of preparing a base body;
a first polishing step of polishing an outer surface of the base body with a first polishing powder, the first polishing powder being an aluminum oxide powder; then
a second polishing step of polishing the outer surface of the base body with a second polishing powder, the second polishing powder being an aluminum oxide powder; and then
performing a film forming step of forming a protective film onto the base body,
wherein when a central particle diameter that is a mode of particle diameters in a particle size distribution is compared between the first polishing powder and the second polishing powder, the central particle diameter of the second polishing powder is 1/10 or less of the central particle diameter of the first polishing powder.

10. The film forming method according to claim 9, further comprising:
after the second polishing step, performing a solvent charging step of adding solvent into a reaction vessel, stirring the solvent and then adding ammonia water into the reaction vessel; and then
performing a base body charging step of placing the base body into the reaction vessel.

11. The film forming method according to claim 10, further comprising:
after performing the base body charging step, performing a polymer charging step of placing polyvinylpyrrolidone into the reaction vessel, the polyvinylpyrrolidone being adsorbed into the outer surface of the base body.

12. The film forming method according to claim 11, further comprising:
after performing the polymer charging step, performing a metal alkoxide charging step of introducing a liquid tetraethyl orthosilicate into the reaction vessel.

13. The film forming method according to claim 12, further comprising:
after performing the metal alkoxide charging step, performing the film forming step, the film forming step including continuing stirring of the solvent for a predetermined period of time to form a glass film covering the outer surface of the base body.

14. The film forming method according to claim 13, further comprising:
after the film forming step, performing a drying step of removing the base body from the reaction vessel and drying the base body.

15. The film forming method according to claim 14, further comprising:
after the drying step, performing a conductor applying step of applying a conductor paste to a surface of the glass film to form a first underlying electrode and a second underlying electrode; and then
heating the base body to cure the base body.

16. The film forming method according to claim 15, further comprising:
after the conductor applying step, performing a plating step of electroplating the first underlying electrode and the second underlying electrode to form a first metal layer on a surface of the first underlying electrode and a second metal layer on a surface of the second underlying electrode.

17. The film forming method according to claim 16, wherein the base body includes:
a first internal electrode; and
a second internal electrode, and
the first internal electrode being spaced from the second internal electrode.

18. The film forming method according to claim 17, wherein:
the first underlying electrode is connected to the first internal electrode by a first penetrating part, the first penetrating part penetrating the protective film and the glass film, and
the second underlying electrode is connected to the second internal electrode by a second penetrating part, the second penetrating part penetrating the protective film and the glass film.

19. An electronic component comprising:
a base body, the base body including:
a first internal electrode;
a second internal electrode, the first internal electrode being spaced from the second internal electrode;
a first underlying electrode; and
a second underlying electrode spaced from the first underlying electrode;
an external electrode that covers a part of an outer surface of the base body; and
a protective film comprised of aluminum oxide, the protective film is located between the base body and the external electrode, wherein:
a film thickness of the protective film in a direction perpendicular to the outer surface of the base body has an average value of 100 nm or less.

20. The electronic component according to claim 19, wherein:
the first underlying electrode is connected to the first internal electrode by a first penetrating part, the first penetrating part penetrating the protective film, and
the second underlying electrode is connected to the second internal electrode by a second penetrating part, the second penetrating part penetrating the protective film.
